(19) United States
(12) Patent Application Publication
(10) Pub. No.: US 2006/0208677 A1
(43) Pub. Date: Sep. 21, 2006

(54) Furniture item, and adjustment mechanism for a furniture item

(75) Inventors: Thomas Schroder, Melle (DE); Stefan Langejurgen, Kirchlengern (DE)

Correspondence Address: Henry M. Feiereisen;Henry M. Feiereisen, LLC, Suite 4714, 350 Fifth Avenue, New York, NY, 10118, US

(73) Assignee: Dewert Antriebs-und Systemtechnik GmbH, Kirchlengern (DE)

(21) Appl. No.: 11/283,607

(22) Filed: Nov. 18, 2005

Related U.S. Application Data
(60) Provisional application No. 60/631,530, filed on Nov. 29, 2004.

(30) Foreign Application Priority Data
Nov. 18, 2004 (DE) 20 2004 017 946.6

(51) Int. Cl. H02P 7/00; G05B 11/32

(52) U.S. Cl. 318/264; 318/625

(57) ABSTRACT

A furniture item includes a fixed first structure, a second structure, and a drive assembly for moving the second structure in relation to the first structure between predefined target positions. The drive assembly has at least two servo drives. An adjustment mechanism is provided for maintaining the second structure in desired alignment with the first structure and includes a control unit for controlling operation of the servo drives, and first and second signal transducer assemblies which are operatively connected to the control unit, wherein one signal transducer assembly interacts with one servo drive, and the other signal transducer assembly interacts with the other servo drives. So long as a movement to any one of the target positions by the second structure in relation to the first structure is accompanied by a simultaneous activation of the first and second signal transducers assemblies, the second structure is in proper alignment to the first structure. When the second structure deviates from the target position, the control unit manipulates operation of one of the servo drives to adjust the movement of the second structure.

### CROSS-REFERENCES TO RELATED APPLICATIONS

This application claims the benefit of prior filed U.S. provisional Application No. 60/631,530, filed Nov. 29, 2004, pursuant to 35 U.S.C. 119(e), the subject matter of which is incorporated herein by reference.

This application claims the priority of German Patent Application, Serial No. 20 2004 017 946.6, filed Nov. 18, 2004, pursuant to 35 U.S.C. 119(a)-(d), the subject matter of which is incorporated herein by reference.

### BACKGROUND OF THE INVENTION

The present invention relates, in general, to a furniture item, and more particularly to an adjustment mechanism for moving one structure of a furniture item with respect to a fixed structure.

Nothing in the following discussion of the state of the art is to be construed as an admission of prior art.

Furniture items of a type involved here relate primarily to chairs or recliners, like beds or armchairs. In particular, beds for use in hospitals or nursing homes should be adjustable in a smooth manner and capable of reaching predefined target positions. The maximum angular adjustment should be relatively small, for example 2°, after a certain number of adjustment cycles, for example 10 cycles. For safety reasons, d.c. motors have been generally used as drives which operate at a safety voltage of 24 or 42 volts. Each of the head and foot portions of the bed are typically provided with two servo drives for adjusting a mattress frame parallel to a base frame. As the mattress frame is necessarily subjected to uneven loads along its length, the servo drives operate at different speeds, a fact that ultimately causes the mattress frame deviate form the desired target positions, when being moved up and down for several times. In other words, the mattress frame assumes an undesired slanted disposition with respect to the base frame, when a parallel adjustment is sought, for example.

It would therefore be desirable and advantageous to provide an improved adjustment mechanism for a furniture item which is simple in structure and thus cost-efficient to manufacture, while still being reliable in operation and ensuring an adjustment to desired target positions.

### SUMMARY OF THE INVENTION

According to one aspect of the present invention, a furniture item includes a fixed first structure, a second structure, a drive assembly for moving the second structure in relation to the first structure between predefined target positions, with the drive assembly having at least two servo drives, and an adjustment mechanism for maintaining the second structure in desired alignment with the first structure, wherein the adjustment mechanism includes a control unit for controlling operation of the servo drives, and first and second signal transducer assemblies operatively connected to the control unit, with the first signal transducer assembly interacting with one of the servo drives and with the second signal transducer assembly interacting with the other one of the servo drives such that a movement to any one of the target positions by the second structure in relation to the first structure is accompanied by a simultaneous activation of the first and second signal transducer assemblies, and a deviation from a target position causes the control unit to manipulate operation of one of the servo drives to adjust the movement of the second structure.

It is to be understood that a reference to a simultaneous activation of the signal transducer assemblies may include a certain time offset which however is within narrow limits as the adjustment speeds of the structure to be adjusted of a furniture item are relatively small. When encountering a deviation from the target position by the second structure beyond admissible tolerances, i.e. one servo drives operates at a greater pace, the signal transducer assembly assigned to this servo drive and actuated causes the control unit to either shut down or at least slow down this servo drive until the other signal transducer assembly is activated, indicating that the target position has been reached. The previously shut down or slowed down servo drive can then be operated again. Decrease in speed may take place over a predefined time period.

According to another feature of the present invention, each of the signal transducer assemblies may include one or more signal transducers which is/are constructed as limit switch. It is hereby possible to operate two servo drives by means of a signal transducer or limit switch because two servo drives are disposed for each of the head and foot portions when, for example, a mattress frame is height-adjusted, and it can be assumed that the load upon both these servo drives is always constant.

According to another feature of the present invention, the signal transducer assemblies may be integrated in the servo drives. This would result in a most simple configuration because no additional components are required. It is also possible to mount the signal transducer assemblies to the second structure. This requires the use of respectively matching actuating elements. This can be realized in an especially simple manner when the signal transducer assemblies are arranged outside a movement range of the structure being respectively adjusted, and that actuating elements are mounted to the second structure. This configuration has the advantage that the signal transducers are accessible in an especially good manner.

According to another feature of the present invention, each of the first and second signal transducer assemblies may include a plurality of switches disposed above one another in a movement path of the second structure and interacting with a lobe on an output member of the drive units. As a consequence, several control operations can be executed while utilizing the entire adjustment path. The signal transducer assemblies are hereby linked by circuits such that groups of units, spaced from one another at same distances with respect to the movement direction of the output member of the servo drives, are linked together. This prevents triggering of a control signal when the signal transducers activated simultaneously in the target position of the structure to be adjusted are operated at a time offset.

For safety reasons, each servo drive may be constructed as low-voltage d.c. motor. Two servo drives are preferably used for adjusting a structure, whereby the number can be increased if need be. The signal transducer assemblies should be installed in areas in which adjustment are most frequent.

The motor current switching of each servo drive may be implemented by a relay control because such controls are cost-efficient and reliable in operation. As an alternative, it is also possible, to use a semiconductor control or to switch the motor current directly from the signal transducer assemblies and/or a hand switch. It would further be possible, to transmit a control signal from each signal transducer assembly to a control unit. It is further possible, to make or cut the motor current or to reduce the current supply.

The signal transducers may also be designated as monitoring switch.

According to another aspect of the present invention, a method of maintaining a movable structure in proper alignment with a fixed structure of a furniture item includes the step of causing a shutdown or at least a slow down of a faster one of two drive units, when only one of two signal transducers is activated in response to a movement of the movable structure to a predefined target position.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a furniture item in the form of a bed, having incorporated an adjustment mechanism according to the present invention and depicting a lowermost position of a mattress frame;

FIG. 2 is a schematic illustration of the bed, with the mattress frame reaching a first target position during upward movement;

FIG. 3 is a schematic illustration of the bed, with the mattress frame assuming an undesired slanted position during continuous upward movement;

FIG. 4 is a schematic illustration of the bed, with the mattress frame in slanted position upon initiation of a corrective measure;

FIG. 5 is a schematic illustration of the bed, with the position of the mattress frame being corrected to assume a horizontal disposition;

FIG. 6 is a schematic illustration of the bed, with the mattress frame during continued upward movement to an uppermost target position; and

FIG. 7 is a block diagram, showing interrelation of components of the adjustment mechanism.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the drawing, and in particular to FIG. 1, there is shown a schematic illustration of a furniture item in the form of a bed, generally designated by reference numeral 10 and having incorporated an adjustment mechanism according to the present invention. For ease illustration, the bed 10 is shown purely schematically in the drawings. The bed 10 has four running wheels 15 to allow its use, i.a. also in a hospital or in a nursing home. The bed 10 includes a base frame 11 as fixed structure, and a mattress frame 12 which is adjustable to move between a lowermost position, shown in FIG. 1, and an unillustrated uppermost position, by means of drive units 13, 14 disposed in the end zones either individually or in pairs. The drive units 13, 14 may be constructed in any conventional form known to the skilled artisan. In the illustrated exemplified embodiment, the drive units 13, 14 are constructed as linear drives in the form of single servo drives.

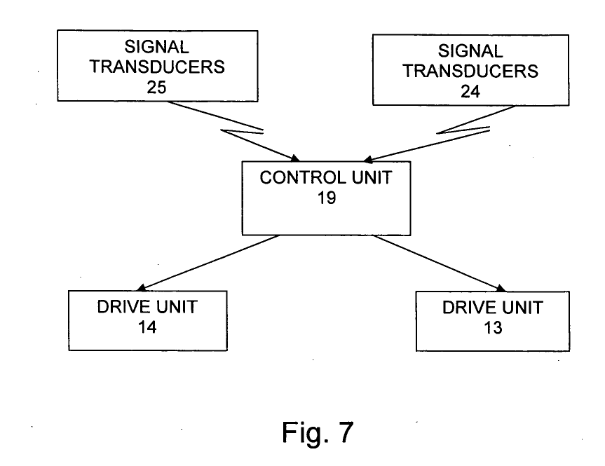

The drive units 13, 14 have each an output member 20, 21, for example a telescopic lifting tube, which is directly coupled to the mattress frame 12 and has a lobe 23 which interacts with a plurality of signal transducers in the form of limit switches 24, 25 disposed in associated switch boxes 26 and arranged above one another in a movement path of the mattress frame 12. The signal transducers 24, 25 produce a signal when acted upon by the lobes 23 for delivery to a control unit 19 (FIG. 7) which processes the received signals in a manner, as will be described hereinafter. The switch boxes 26 are mounted on the drive units 13, 14 and have a top opening for allowing the associated output members 20, 21 to move in and out of the switch boxes 26.

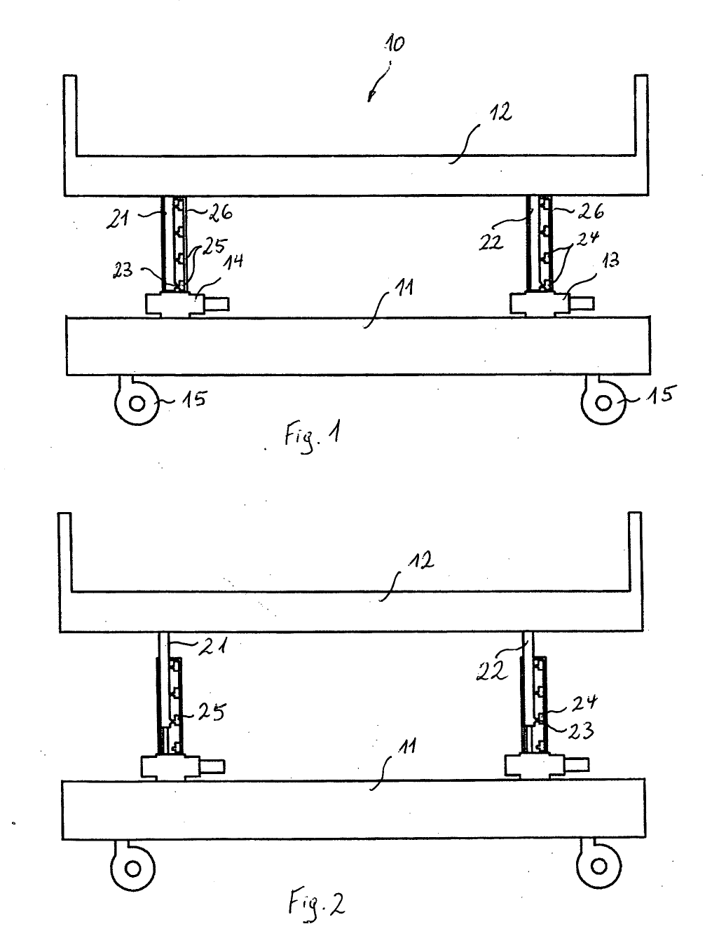

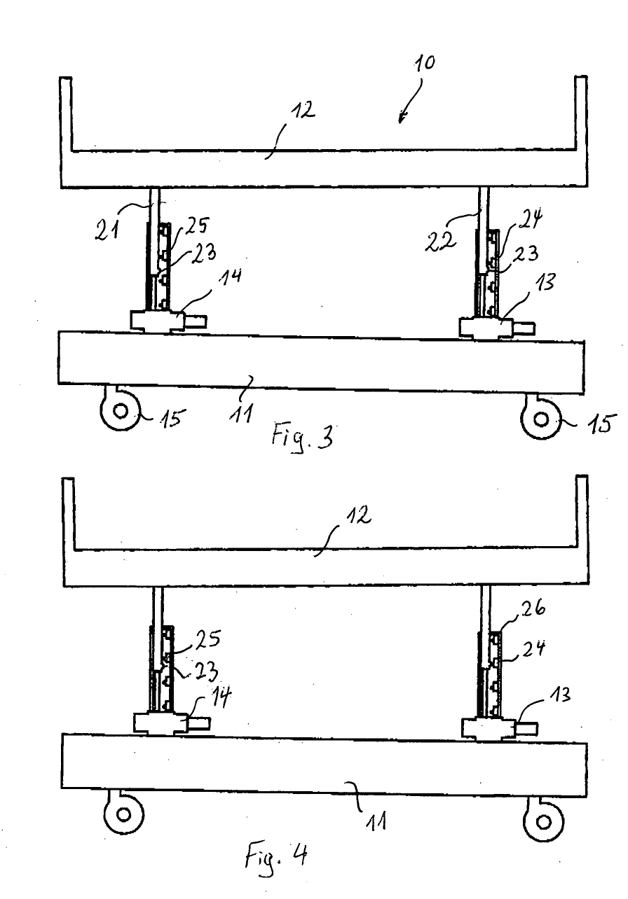

The mode of operation of bed 10 is as follows: When the mattress is intended to be moved up from the lowermost position, shown in FIG. 1, the drive units 13, 14 are started to move the lifting tubes 22 out. So long as the drive units 13, 14 move the lifting tubes 20, 21 coextensively, and the switches 24, 25 in the same hierarchy in the switch boxes 26 are actuated simultaneously, the mattress bed 12 will be moved in horizontal disposition and parallel to the base frame 11. This is shown in FIG. 2, depicting the actuation of the second switches 24, 25 simultaneously by the lobes 23 of the lifting tubes 21, 22.

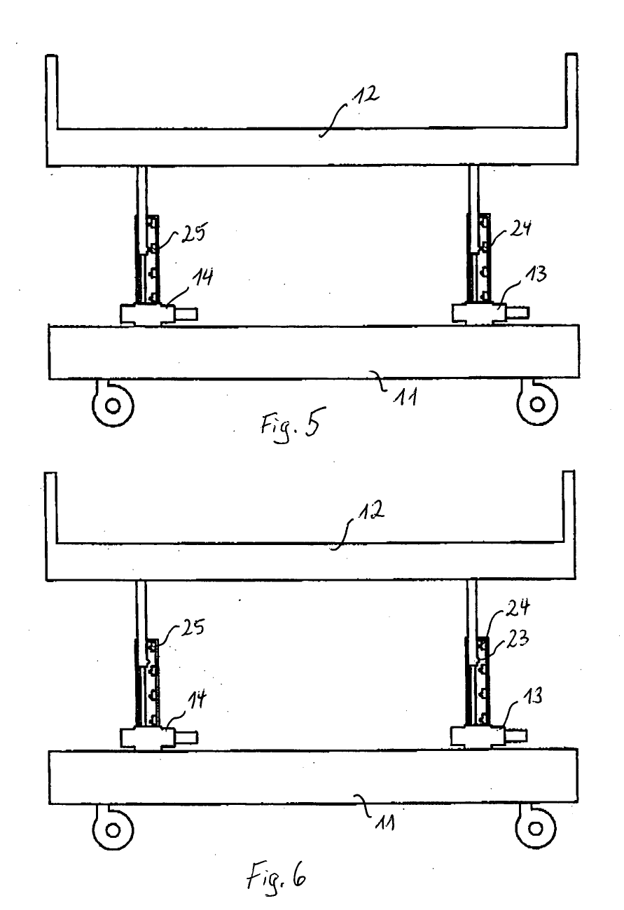

However, in the event one of the drive units 13, 14 operates at a slower pace, the lobes 23 in the switch boxes 26 become misaligned and the mattress 12 assumes a slanted disposition. This is shown in FIG. 3. The drive unit 14 for example operates here at a slower pace following the actuation of the two lower switches 24, 25, so that the lobe 23 of the lifting tube 21 lags behind the upward movement of the lobe 23 of the lifting tube 22. As a consequence, the lobe 23 of the lifting tube 22 actuates the next switch 24 of the switch box 26 in the hierarchy before the lobe 23 of the lifting tube 21 actuates the next switch 25 in the hierarchy of its switch box 26. In response to the actuation of a switch 24 and absence of an actuation of switch 25, the control unit 19 causes shutdown or at least a slowdown in the output speed of the drive shaft 13 until the lobe 23 of the lifting tube 21 catches up and triggers the switch 25. In other words, drive unit 14 continuous to operate while drive unit 13 stops or is slowed down. This situation is shown in FIG. 4. When the switches 24, 25 at same level in the hierarchy of switch boxes 26 are jointly actuated, as shown in FIG. 5, the mattress frame 12 assumes again a horizontal disposition, at which point the control unit 19 restarts operation of the drive unit 13. Both drive units 13, 14 move now the mattress frame 12 in synchronism in the direction to the uppermost position, as shown in FIG. 6.

While the mode of operation has been described in conjunction with an upward movement of the mattress frame 12, the same principle is, of course, applicable for a downward movement of the mattress frame 12.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A furniture item, comprising:
a fixed first structure;
a second structure;
a drive assembly for moving the second structure in relation to the first structure between predefined target positions, said drive assembly having at least two servo drives; and
an adjustment mechanism for maintaining the second structure in desired alignment with the first structure, said adjustment mechanism including a control unit for controlling operation of the servo drives, and first and second signal transducer assemblies operatively connected to the control unit, with the first signal transducer assembly interacting with one of the servo drives and with the second signal transducer assembly interacting with the other one of the servo drives such that a movement to any one of the target positions by the second structure in relation to the first structure is accompanied by a simultaneous activation of the first and second signal transducer assemblies, and a deviation from a target position causes the control unit to manipulate operation of one of the servo drives to adjust the movement of the second structure.

2. The furniture item of claim 1, wherein each of the signal transducer assemblies includes at least one signal transducer constructed as a limit switch.

3. The furniture item of claim 1, wherein the signal transducer assemblies are integrated in the servo drives.

4. The furniture item of claim 1, wherein each of the first and second signal transducer assemblies includes a plurality of switches disposed above one another in a movement path of the second structure and interacting with a lobe on an output member of the drive units.

5. The furniture item of claim 4, wherein the output member of the drive units is a lifting tube.

6. The furniture item of claim 4, wherein the switches of the first and second signal transducer assemblies are spaced from one another at same distances.

7. The furniture item of claim 1, wherein the servo drive is a low-voltage d.c. motor.

8. The furniture item of claim 7, wherein the control unit includes a motor circuit constructed as relay control.

9. The furniture item of claim 7, wherein the control unit includes a motor circuit constructed as semiconductor control.

10. The furniture item of claim 1, wherein the control unit shuts down or at least slows down operation of the one servo drive.

11. A method of maintaining a movable structure in proper alignment with a fixed structure of a furniture item, comprising the step of causing a shutdown or at least a slow down of a faster one of two drive units when only one of two signal transducers is activated in response to a movement of the movable structure to a predefined target position.
